(19) United States
(12) Patent Application Publication
(10) Pub. No.: US 2005/0145086 A1
(43) Pub. Date: Jul. 7, 2005

(54) Combination pencil sharpener bottle cap

(76) Inventor: Monte D. Mohr, Cameron Park, CA (US)

Correspondence Address: Monte D. Mohr, 4300 McNeil Rd, Cameron Park, CA, 95682, US

(21) Appl. No.: 10/751,073

(22) Filed: Jan. 5, 2004

(51) Int. Cl. B26D 1/00

(52) U.S. Cl. 83/651

(57) ABSTRACT

A combination pencil sharpener bottle cap that threadably fits unto any conventional plastic beverage container creating a new and useful product that both sharpens pencils and facilitates a much needed pencil shavings receptacle that is particularly useful in elementary school classrooms where large volumes of wood-encased pencils are sharpened daily. Said combination pencil sharpener bottle cap is integrally attached to a pencil sharpener housing 1; and, wherein said screw-threaded cap 6 defining a pencil-receiving opening 9; integrally attached to said housing 1; with housing further comprising a sharpening assembly 16 positioned to sharpen a pencil, 14 inserted into said pencil-receiving opening 9 and wherein, said threadably attached conventional plastic beverage container 12 stores pencil shavings that fall by gravity from said sharpening assembly 16, thus creating a new, useful and much needed storage receptacle out of common plastic beverage containers that can be easily threaded on by small hands nearly eliminating all accidental spillage of pencil shavings unto carpets, into desks or over elementary school classroom activity tables, that is readily available in abundance recyclable, friendly to the environment and easily disposed of properly, that can be hand-threaded unto said combination pencil sharpener bottle cap, a convenience, previously not available in prior art pencil sharpeners, that is simple to use, and inexpensive to manufacture.

### BACKGROUND OF THE INVENTION

1. Field of the Invention

This invention relates to, office products, and more specifically, to a pencil sharpener bottle cap combination, for use in elementary school classrooms that fits onto any conventional plastic beverage container to facilitate a new, useful and readily available pencil shavings receptacle, that is easily manipulated by small hands, with large capacity for storage of pencil shavings, that both sharpens wood encased pencils and stores the pencil shavings, that is inexpensive to manufacture, recyclable and easily disposed of properly.

2. Description of the Prior Art

Manually operated pencil sharpeners have long been known. Electrically powered, either corded or cordless (battery powered) pencil sharpeners are now well known. Such pencil sharpeners have a shell or housing with a cavity in which a sharpening assembly is mounted. Many different sharpening assemblies are well known in the art and are applicable for sharpening common writing pencils, by cutting the wood to expose and sharpen the lead or graphite (collectively, “lead”) encased therein. This normal sharpening process creates shavings and dust (collectively “shavings”), which are typically trapped within the housing, (housing may or may not have a shavings receptacle), and periodically discarded by the user when full.

In one prior art configuration illustrated in U.S. Pat. No. 4,815,507, a removable faceplate is provided allowing access to shavings trapped in a receptacle or cavity located directly below the pencil entrance hole. In a sense, the cavity and lower faceplate cooperate to form a receptacle for the shavings. This configuration is most common in battery powered pencil sharpeners. In another prior art configuration described in U.S. Pat. No. 370,940 a removable lower cup and/or drawer fits into the housing and/or cavity for catching or trapping the shavings. Yet another patent of interest, U.S. Pat. No. 6,553,882, features a pivotal receptacle with an opening and closing position. The open position exposes the cavity during emptying of pencil shavings and the closed position secures the housing to avoid accidental spillage. Again, another patent of note, U.S. Pat. No. 6,571,480, features no pencil shavings receptacle, cup or cavity at all.

Periodically, the pencil shavings must be discarded. The faceplate, cup, drawer, etc. (collectively “receptacle”) is removed from the pencil sharpener for this purpose. In a cup or drawer arrangement, spillage of the shavings is likely when the cup or drawer is removed due to over filling of the cup or drawer with shavings. One removed from the pencil sharpener, the cup or drawer is unstable and shavings are easily spilled. In faceplate arrangements, the shavings are particularly difficult to control and the spillage frequently occurs with any amount of shavings.

In some of these arrangements, the receptacle and housing are provided with retention means to enable for nap engagement of the receptacle with the housing to positively position and retain the receptacle. However, such an arrangement causes sudden snap-disengagement of the receptacle from the housing and often results in spillage of the shavings. Typically, upon disengagement of the shavings receptacle, or during storage, the cup, or drawer (collectively “receptacle”) is lost and the user, unable to locate the original receptacle, resorts to other makeshift means of shavings retention such as a small cardboard box particularly in motorized models or the use of one's own cupped hands to secure the shaving as they drop down or the user may simply stand over a nearby wastebasket and allow debris and pencil dust, (shavings) to freely fall into a waste container where ultimately, much of the pencil shavings miss the container and fall unto the floor.

Additionally, since there are numerous different pencil sharpener configurations encompassed by the crowded prior art, a user's unfamiliarity with a certain pencil sharpener contributes to the likelihood of spillage. Spilled shavings and lead (“graphite”) cause stains that are difficult to clean, and therefore, require continual clean up as is so typical in elementary school classroom situations.

There has existed a long and unfulfilled need in this area of technology for an improved pencil sharpener configuration for dealing with debris (“shavings”) generated by the public, and specifically students and their teachers in elementary school classrooms. Therefore, it is desirable to depart from conventional concepts and designs of prior art, and in so doing, provide an apparatus primarily developed for classroom use, easily manipulated by small hands, capable of facilitating an environmentally friendly pencil (“shavings”) receptacle with increased storage capacity for pencil shavings, that is inexpensive to manufacture, recyclable, and easy to dispose of properly.

### BRIEF SUMMARY OF THE INVENTION

The wood encased pencil is well known to be a necessary component of elementary school classroom education. All students, particularly grades K-6 not only use the pencil daily, but are required to keep it sharp and ready. Pencil supply and maintenance is a daily concern for teachers as major learning time is lost sharpening them, cleaning up debris that fall unto floors and inside desks. As a result, many teachers ban the student use of pencil sharpeners altogether, and designate pencil sharpening and replenishment of supply (freshly sharpened pencils)to a few trusted students or parents who will donate early morning or after school time to sharpen and replace pencil inventory for the next day.

Therefore, in view of the forgoing disadvantages inherent in the various designs and configurations of pencil sharpeners now present in the known art, my invention provides a new “screw-threaded cap” configuration as an integral part of the pencil sharpener housing and mechanism. This new construction is particularly useful for the sharpening of wood encased pencils, because it provides a pencil sharpener housing configuration that can be threadably attached to any conventional plastic beverage container creating a new and useful pencil sharpener shavings receptacle from any conventional plastic beverage container, with increased storage capacity for shavings, that is easily manipulated by small hands, inexpensive to manufacture, recyclable, environmentally friendly and easily disposed of properly.

The combination pencil sharpener bottle cap is threadably engaged by hand unto the neck of said conventional plastic beverage container, creating an air tight seal whereby insuring that pencil shavings will not leak or drop unto a floor or desk by gravity, and as the pencil shavings drop down and collect in the plastic receptacle (conventional plastic beverage container) a new and useful storage device for pencil shavings is formed, formally not present in prior art pencil sharpeners, rendering this cenfiguration particularly useful in elementary school classrooms where large volumes of wood encased pencils are sharpened daily.

Additionally, as pencil havings accumulate within the plastic beverage container, the user can easily observe capacity due to the transparent nature of the plastic materials so commonly used in the manufacture of said containers, enabling accurate visual determination of pencil havings accumulation, further reducing the possibility of spillage from over filling as is common in prior art pencil sharpeners earlier mentioned.

In addition, a screw-threaded cap and pencil sharpener combination for fitting on conventional plastic beverage containers is particularly useful for children in elementary school classrooms where the use of empty plastic beverage containers (plastic soda bottles) is already common practice for storage of various school supplies, and yet more common to students and their teachers as an accepted means for storage of “desk-side” drinking water. Thus, a combination pencil sharpener bottle cap that threadably fits unto a conventional plastic beverage container, a container already common to students and readily available in abundance, will create a new and useful classroom product, that sharpens wood encased pencils and also provides a storage receptacle for pencil shavings, previously not available in prior art pencil sharpeners, that is easy for little hands to manipulate, that nearly eliminates all accidental spillage of pencil shavings unto carpets, into desks or over classroom activity tables, that is recyclable, inexpensive to manufacture, simple to use, friendly to the environment and easily disposed of properly.

In an office setting as in the classroom, this preferred embodiment, the combination pencil sharpener and screw-threaded cap configuration, greatly enhances stability and control, for office workers, during normal use while the pencil sharpener is upright on a desk, table, or in the users hand. In the open position, (plastic beverage container has been removed to empty shavings), the housing being integrally attached, becomes a spout and serves as a temporary control for residual shavings (shavings that may have become lodged inside the cutting area of the sharpener housing) facilitating efficient disposal of residual shavings, pencil lead dust (“graphite”) debris, minimizing need for clean up of surrounding floors and carpets as is so common with prior art pencil sharpeners earlier mentioned.

Therefore, there has thus been outlined, rather broadly, the more important features of the invention in order that the detailed description, thereof, that follows may be readily understood, and in order that th present contributions to the art may be better appreciated. There are, of course, additional features of the invention that will be described hereinafter and which will form the subject matter of the claims appended hereto. As such, the general purpose of the present invention, which will be described subsequently in detail later, is to provide a pencil sharpener capable of threadably attaching unto any conventional plastic beverage container to create a new and useful office or school classroom product with increased storage capacity for pencil shavings, particularly helpful to elementary school students and their teachers that is, inexpensive to manufacture, easily manipulated by small hands, recyclable, easily to dispose of properly, which maintains many advantages of the pencil sharpeners mentioned herein, and many novel features, that result from a combination pencil sharpener bottle cap, not anticipated, rendered obvious, suggested, or even implied by prior art in the field of pencil sharpeners, either alone or in any combination thereof.

### BRIEF DESCRIPTION OF SEVERAL VIEWS OF THE DRAWING

FIG. 1. is a perspective view of the combined pencil sharpener bottle cap configuration with integral threaded cap for fitting on plastic beverage containers in the closed position (screw-threaded cap threadably attached to plastic beverage container creating a tight seal) showing my invention. The broken lines, being for illustrative purposes only and forming no part of the claimed invention; and,

FIG. 2. is a perspective view of the combined pencil sharpener bottle cap configuration with integral threaded cap for fitting on plastic beverage container in open position (screw-threaded cap disengaged from plastic beverage container) showing my invention. The broken lines, being for illustrative purposes only and forming no part of the claimed invention; and,

FIG. 3. is a perspective view of the combined pencil sharpener bottle cap combination with integral threaded cap of FIG. 1 for threading onto plastic beverage container in pen position, (plastic beverage container disengaged from threaded cap) showing my invention; and,

FIG. 4 is a side elevational view of the combined pencil sharpener bottle cap combination, in pen position, for fitting on empty conventional plastic beverage container of FIG. 1; and,

FIG. 5 is a bottom view of the combined pencil sharpener bottle cap combination, in pen position, for fitting on empty conventional plastic beverage container of FIG. 1.

### DETAILED DESCRIPTION OF THE INVENTION

Although one preferred embodiment of the invention is explained in detail, it should be understood that the invention is not limited in its scope to the details of construction and the arrangement of components or illustrations set forth in the following description or illustrated in the drawings The invention is capable of other embodiments and of being used in various ways. Also, in describing the preferred embodiment, specific terminology is used for the sake of clarity and it should be understood that each specific term used includes any technical equivalents, which may operate in a similar manner to accomplish the same or similar purpose.

In the past, pencil sharpeners have had various receptacles for shavings retention that were primarily unique to that specific pencil sharpener, yet subject to removal from it's own housing to empty pencil shavings. Other prior art configurations utilized integral receptacles that either remained attached by some type of snap-on device, or were hingedly attached to the housing during normal sharpening operation and emptying. Still other prior art utilized a drawer receptacle that moved freely with friction as its only restraint from falling out, while others had top pencil entrance holes and could threadably attach unto a barrel or cylindrical shaped storage receptacle. Such configurations were and are still inherently unstable, (especially when operated by elementary school children) thus prone to spillage of shavings, unfriendly to the environment, have minimal storage capacity, not recyclable or easy to dispose of properly, manufactured to fit one receptacle size, therefore, worthless when receptacle is misplaced or lost.

Therefore, referring now more specifically to FIG. 1, on page I of the drawings, my present invention provides a screw-threaded cap 6 configuration that is permanently attached to the pencil sharpener housing 1 during normal sharpening operation and while emptying of shavings from the pencil sharpener. In use, the screw-threaded cap 6 is threadably engaged to a conventional plastic beverage container 12 in a well-understood manner. The empty plastic beverage container 12 is hand secured into the screw-threaded cap 6-pencil sharpener bottle cap combination creating a new and useful shavings receptacle 8 from said conventional beverage container 12 with a large capacity for storage of pencil shavings. The plastic beverage container 12, when full to capacity, can be easily removed by hand, screwing it off the screw threaded cap 6 and than discarded or reused by threading it back unto the screw threaded cap 6 integrally attached to the housing 1 of the pencil sharpener.

With the screw threaded cap 6 configuration integrally attached to the pencil sharpener housing 1, an air tight seal is created between the housing 1 and plastic beverage container 12, at the screw-threaded neck 13, creating stability in handling, and a spillage free shavings/storage receptacle 8 that is reusable, with a large storage capacity, formally not available in prior art pencil sharpeners.

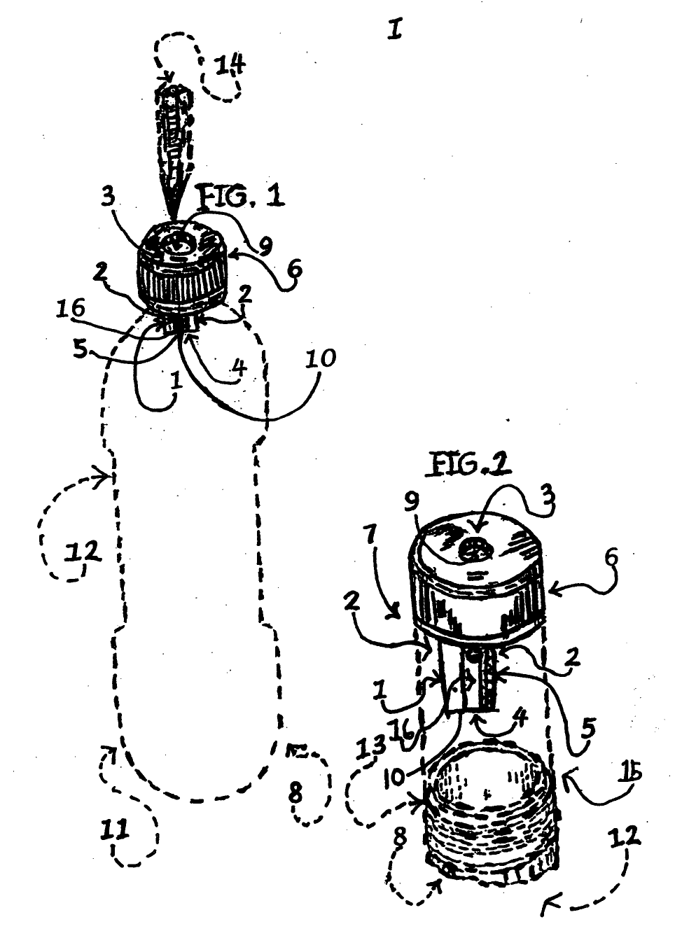

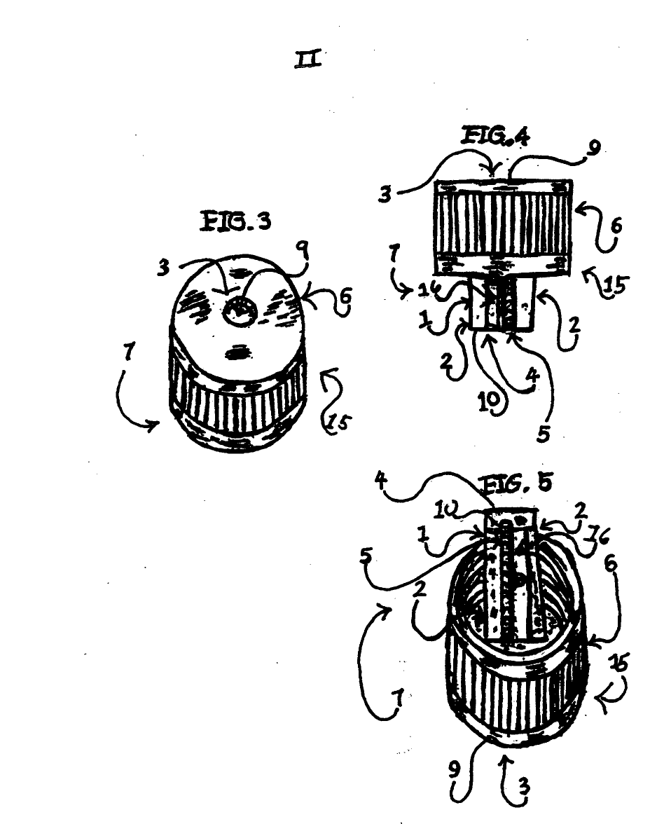

Referring to the description of drawings in FIGS. 1,2,4,5, a housing 1 is shown having a pair of side walls 2 spaced from one another, an open end 3 defined between said pair of sidewalls 2, and a bottom wall 4 extending between said pair of spaced sidewalls 2, and adjacent to said open end 3, each pair of said spaced sidewalls 2 having an elongated grove 5 adjacent to said open end 3; extending up to and adjacent to bottom wall 4 and, an integrally attached screw-threaded cap 6 adjacent to said pair of side walls 2, integrally attached to the housing 1 at the open end 3, and defining the rearward edge 10 of the embodiment, positioned to abut said rearward edge 7 of said screw-threaded cap 6 to said plastic beverage container 12 effecting a tight seal at threaded neck 13 of plastic beverage container 12, in the closed position 11; and,
Referring to FIG. 2, of the description of drawings, a screw-threaded cap 6 is shown with integrally attached housing 1 in pen position 15 at reward edge 7 of screw-threaded cap 6 having a pair of side walls 2 spaced from an another, an open end 3 defined between said pair of sidewalls 2 and a bottom wall 4 extending between said pair of spaced sidewalls 2, and adjacent to said open end 3 each of said pair of spaced sidewalls 2 having an elongated grove 5 adjacent to said openend 3; extending up to and adjacent to bottom wall 4; and,
an integrally attached screw-threaded cap 6 adjacent to said pair of side walls 2, integrally attached to the housing 1 at the open end 3, and defining a rearward edge 10 of the embodiment, positioned to abut said rearward edge 7 of said screw-threaded cap 6 to said plastic beverage container 12 effecting a tight seal at threaded neck 13 of plastic beverage container 12 in the closed position 11 wherein said housing 1 defines a pencil-receiving opening 9 and said office product further comprising a sharpening assembly 16 mounted within said housing 1 and positioned to sharpen a pencil (14) inserted into said pencil-receiving opening 9.

Referring to FIG. 5 of description of drawings on page II, a bottom view of the screw-threaded cap 6 is shown with integrally attached pencil sharpener housing 1, in open position (15), having a pair of side walls 2 spaced from one another, an open end 3 defined between said pair of sidewalls 2, and a bottom wall 4 extending between said pair of spaced sidewalls 2 and adjacent to said open end 3 each of said pair of spaced sidewalls 2 having an elongated grove 5 adjacent to said open end 3 extending up to and adjacent to bottom wall 4; and, said integrally attached screw-threaded cap 6 adjacent to said pair of side walls 2 integrally attached to the housing 1 at open end 3 defining a rearward edge 10 of the embodiment, positioned to abut said rearward edge 7 of said screw-threaded cap 6 to said plastic beverage container 12 effecting a tight seal at threaded neck 13 of plastic beverage container 12 in closed position 11 as shown on page I of the drawings; wherein said housing 1 defines a pencil-receiving opening 9 and said screw-threaded cap 6 further comprising a sharpening assembly 16 mounted unto said integrally attached housing 1 positioned to sharpen a pencil 14 inserted into said pencil-receiving opening 9.

Having thus described in particular certain embodiments of my invention, various alterations, modifications, and improvements will readily occur to those skilled in the art. For example, it should be understood that the pencil sharpener housing with screw-threaded cap might be used as a cap to seal empty plastic beverage containers of differing sizes and shapes used to store supplies in an office setting other than just to be used for pencil sharpening. In elementary school classrooms, for example, the screw-threaded cap may be used to seal plastic containers of various sizes and shapes for storage of pencils, ballpoint pens, erasers, paperclips, crayons, felt tip pens, and over-head projector dry-erase writing devices.

Additionally, the screw-threaded cap may have various configurations. For example, two entrance holes positioned atop and adjacent to each other could be a valuable addition. Also, the screw threaded cap interface may have top or side entrance holes for pencils of various uses. The entrance holes may be configured with different diameters to accommodate various applications. For example, large diameter beginner's (thick) writing pencils, commonly used by kindergarten children in the classroom, require large entrance holes. Similarly, cosmetic-make-up pencils, and eyebrow-markers, require various entrance hole sizes to accommodate the thinner leads and circumferences of this style of pencil. In addition, carpenters commonly utilize a line marking pencil that is more rectangular with rounded edges, more flat than circular, a shape requiring a custom entrance hole configuration.

It should also be appreciated that the pencil sharpener housing may be secured to the cap by various means. One possible consideration might be an inner cap member connection concentrically received within the outer cap member, with inner cap having a top wall and a cylindrical side wall secured by the internal threads to threadably couple the inner cap to the threaded neck of the plastic beverage container. Another possible configuration would be a two-piece arrangement with cap and coupling ring secured by a tab to hand snap into place creating a one-piece embodiment. Another possible modification to consider would be an exchangeable threadably attached plastic inner plug that can be screw threaded unto the inner threaded outer cap of the embodiment for quick removal or replacement of said combinatlon pencil sharpener bottle cap. A remevable entrance hole insert of some type capable of varying plug-in sizes for writing devices from wood-encased pencils to crayons and chalk could also be a possible useful modification

A one-piece cast or molded arrangement (preferred embodiment), or an adhesively secured cap and housing using various bonding agents, as poxy, or polymer mixtures enabling a permanent bond securing screw threaded cap to the pencil sharpener housing are all possible alternatives. Neck tabs might also be added as a conveniene feature minimizing possible separation of cap and housing from the plastic beverage container while emptying pencil shavings.

Such alterations, modifications and improvements as are made obvious in this disclosure are intended to be part of this description though not expressly stated herein, and are intended to be within the spirit and scope the invention.

I. An office product that threadably fits unto conventional plastic beverag containers, that sharps pencils, with said office product comprised of;
a housing having a pair of side walls spaced from one another, an open end defined between said pair of sidewalls, a bottom wall extending between said pair of spaced sidewalls; and,
adjacent to said open end, each of said pair of spaced sidewalls sharing an elongated grove adjacent to said open end; extending up to and adjacent to bottom wall; and,
a screw-threaded cap adjacent to said pair of side walls, integrally attached to the housing at the open end, and defining a rearward edge of the embodiment, positioned to abut said rearward edge of said screw-threaded cap to said plastic beverage container, effecting a tight seal at threaded neck of plastic beverage container, in the closed position; and,
wherein said housing defines a pencil-receiving opening; and, said office product further comprising a sharpening assembly mounted within said housing and positioned to sharpen a pencil inserted into said pencil-receiving opening.

II. A pencil sharpener, as in claim 1, for elementary school classroom students that threadably connects to conventional plastic beverage containers comprised of:
a housing having a pair integrally attached side walls spaced from one another, an open end defined between said pair of sidewalls, and a bottom wall extending between said pair of spaced sidewalls; and,
adjacent to said open end, each of said pair of spaced sidewalls sharing an elongated grove adjacent to said open end; extending up to and adjacent to bottom wall; and,
a screw-threaded cap adjacent to said pair of side walls, integrally attached to the housing at the open end, and defining a rearward edge of the embodiment, positioned to abut said rearward edge of said screw-threaded cap to said conventional plastic beverage container effecting a tight seal at threaded neck of conventional plastic beverage container, in the closed position; and,
wherein said housing defines a pencil-receiving opening; and, said pencil sharpener further comprising a sharpening assembly mounted within said housing and positioned to sharpen a pencil inserted into said pencil-receiving opening.

III. A bottle cap, for fitting on conventional plastic beverage containers as in claim 2 comprised of:
an integrally attached housing, having a pair of side walls spaced from one another, an open end defined between said pair of sidewalls, and a bottom wall extending between said pair of spaced sidewalls; and, adjacent to said open end, each of said pair of spaced sidewalls having; an elongated grove adjacent to said open end; extending up to and adjacent to bottom wall and, said screw-threaded cap adjacent to said pair of side walls, integrally attached to the housing at the pen end, and defining rearward edge of the embodiment, positioned to abut said rearward edge of said screw-threaded cap to said conventional plastic beverage container effecting a tight seal at threaded neck of plastic beverage container, in the closed position; and,
wherein said screw-threaded cap defining a pencil-receiving opening; integrally attached to said housing; with housing further comprising a sharpening assembly positioned to sharpen a pencil inserted into said pencil-receiving opening and wherein, said threadably attached conventional plastic beverage container stores pencil shavings that fall by gravity from said sharpening assembly.
